(19) United States
(12) Patent Application Publication
(10) Pub. No.: US 2026/0139118 A1
(43) Pub. Date: May 21, 2026

(54) METHOD FOR THE DEGRADATION OF EPOXY HYBRID RESIN

(71) Applicant: Evonik Operations GmbH, Essen (DE)

(72) Inventors: Wilfried KNOTT, Essen (DE); Horst DUDZIK, Essen (DE)

(21) Appl. No.: 19/383,618

(22) Filed: Nov. 8, 2025

(30) Foreign Application Priority Data
Nov. 19, 2024 (EP) 24213820.4

(51) Int. Cl. C08J 11/24; B29B 17/02; B29K 83/00

(52) U.S. Cl. CPC C08J 11/24; B29B 17/02; B29K 2083/00; C08J 2383/04

(57) ABSTRACT

The invention relates to a method for the degradation of epoxy hybrid resin which contains at least one chemically incorporated siloxane, wherein the at least one siloxane chemically incorporated in the epoxy hybrid resin is chemically incorporated into the epoxy hybrid resin via at least two SiC bonds, and wherein the silicon fraction, expressed in percent by mass of silicon, based on the total epoxy hybrid resin is 1.5 percent by mass≤silicon fraction≤10 percent by mass, wherein the epoxy hybrid resin is contacted with a mixture of at least one alkali metal alkoxide and at least one alcohol.

### CROSS REFERENCE TO RELATED APPLICATIONS

The present application claims priority under 35 USC § 119 to European application EP 24213820.4, filed on Nov. 19, 2024, the contents of which is incorporated herein by reference in its entirety.

### FIELD OF THE INVENTION

The present invention lies within the field of epoxy resins and of silicones. In particular, the invention relates to a method for the degradation of epoxy hybrid resin.

### BACKGROUND OF THE INVENTION

Wind turbines can be a worthwhile option for energy generation. For example, according to a requirement of the German Wind Energy at Sea Act (WindSeeG), in the Federal Republic of Germany alone, wind turbines with an output of at least 30 gigawatts will be installed on the open sea by 2030. By 2035, the total offshore output is to rise to 40 gigawatts and by 2045, at least 70 gigawatts are planned. However, the recycling of wind turbine rotor blades is difficult and may disrupt the life-cycle assessment of the wind turbines.

To satisfy the requirements that the wind turbines themselves be as light as possible and that the rotor blades should withstand even severe storms undamaged, a large part of today's rotor blades are manufactured from glass fibre reinforced plastic, or GFRP for short. The nacelle casing of a wind turbine as well may usually be made of glass fibre reinforced plastic. Glass fibre reinforced plastic is a so-called glass fibre composite material, which may be distinguished, for example, by having a glass fibre support which is impregnated with a synthetic resin. Epoxy resin, for example, can be used as synthetic resin for such glass fibre composite materials.

The recycling of used glass fibre composite materials or those to be disposed of is problematic, as the components of the glass fibre composite materials are very difficult and therefore costly to separate from each other. A very conservative estimate may thus be made that as of 2025, for example, rotor blades alone with a total weight of 25 000 tonnes may end up as waste annually. Other estimates assume possibly even higher amounts of waste, which could be, for example, in the order of 40 000 to 60 000 tonnes per annum.

It would be desirable, especially in view of such expected amounts of waste, not only to pass on the used glass fibre composite materials, or those to be disposed of, as waste, but also to recycle them more rationally. It would be particularly desirable to be able to separate the valuable glass fibres as intactly as possible from the synthetic resin, in order to be able, for example, to process these glass fibres into valuable secondary products again and thus avoid them being placed into landfills.

Pyrolytic processes, which are limited essentially to the recovery of the fibre components, are described, for example, by the Dutch Organisation for Applied Scientific Research (TNO) in Circular Biobased Delta under the title “TNO geeft afgedankte windmolenwieken een tweede leven”, Nieuwsbericht, 18/10/2022 as a repost by Romy de Weert of “Change.inc” (Circular Biobased Delta (Oct. 18, 2022), TNO geeft afgedankte windmolenwieken een tweede leven—Circular Biobased Delta, https://circularbiobaseddelta.nl/nieuws/tno-geeft-afgedankte-windmolenwieken-een-tweede-leven/), which is based on a collaboration with Brightlands Materials Center, which has resulted in an oxygen-free pyrolysis process at approximately 500° C., which exposes the fibres of the fibre composite material, so that they can be processed into other composite materials. The resulting pyrolysis coal is to be used for soil improvement in a similar way to biochar.

Dedicated to the issue of the recycling of products containing epoxy resin, such as printed circuit boards and glass fibre fabrics, the teaching of WO 96/16112 A1 aims to bring the products containing epoxy resin into contact with one or more polar solvents and thereby transfer fractions of the epoxy resin to the liquid phase; high temperatures between 14° and 280° C., possibly accompanied by the use of ultrasound or else possibly pressure vessels (autoclaves), with fairly long treatment times as well, reduce the attractiveness of this process.

Focusing on the recycling of the glass fibre reinforced plastics already used, WO 2023/152245 A1 teaches a process for disintegrating epoxy-based polymers or fibre-reinforced epoxy-based polymers, the process comprising a step of contacting the epoxy-based polymers or fibre-reinforced epoxy-based polymers with a solvent mixture containing toluene and an organometallic dehydrogenation catalyst. The dehydrogenation catalyst used therein consists of ruthenium and at least one tridentate organic ligand, such as trimethylenemethane (TMM), 1,1,1-tris(diphenylphosphinomethyl)ethane (Triphos) or tris((diphenylphosphino)methyl)amine (N-Triphos). According to the teaching presented in WO 2023/152245 A1, including on model systems, the hydrogenative cleavage of the glycidyl residue (—O—CH₂—CHOH—CH₂—O—) bridging pairs of bisphenol A molecules delivers the fibre material (for example, the glass fibre), in varying yields bisphenol A and a viscous, brown oil, whose composition remains unclear. Whether the expensive catalyst used once can be reused for further recycling steps is questionable. The combination of the rare and precious platinum metal ruthenium with costly tridentate ligands in a toluene solution, together with the usage amounts this requires (6 percent by mass based on the mass to be recycled) and the time- and energy-intensive process conditions (160° C./16 hours), cause the skilled person to doubt that this recycling method, disclosed in WO2023/152245 A1, will be able to become established on a large scale and for the rotor geometries that are common today, with lengths of up to 90 metres.

Utilizing the solubility of amorphous polylactic acid in methyl methacrylate, Dorgan et al. (Dylan S. Cousins, Bin Tan, Jackson Howell, Yasuhito Suzuki, Joseph R. Samaniuk, Daniel M. Knauss and John R. Dorgan, “Styrene-Free, Partially Biobased Resin System for Thermoplastic Composites. I. Rheological Properties and Preliminary Panel Fabrication” in ACS Sustainable Chem. Eng. 2019, 7, 7, 6512-6521, DOI:10.1021/acssuschemeng.8b04229) used glass fibres to produce an epoxy resin-free rotor blade material. The plates produced from this combined thermoplastic resin were strong and durable enough to be used in turbines or motor vehicles. The plates could be dissolved in fresh monomer and the exposed glass fibres removed in a physical way, allowing the material to be remoulded into new products of the same type. The lack of both suitable and available bioplastics limits the use of this interesting conceptual approach. In addition, only long-term studies can provide information on the extent to which a composite material partially composed of plant polymers can successfully withstand attacks such as biofouling (think offshore wind turbines), for example.

Hafeezullah Memon, Yi Wei and Chengyan Zhu (Polymer Testing 105 (2022), 107420, DOI: 10.1016/j.polymertesting.2021.107420) describe, in their review article “Recyclable and reformable epoxy resins based on dynamic covalent bonds—Present, past, and future” the progress towards the production of recyclable and formable epoxy resins through the incorporation of dynamic, covalent bonds. In addition to the use of the Diels-Alder or Retro-Diels-Alder reaction, transesterification, the forming or cleavage of disulfide bonds, Schiff base chemistry, boroxine bonds, hexahydro-s-triazine derivatives, silyl ether bonds, boronic esters, etc., the authors refer in this context to the work of X. Wu et al. (Xiao Wu, Xin Yang, Rang Yu, Xiao-Juan Zhao, Ying Zhang and Wie Huang “A facile access to stiff epoxy vitrimers with excellent mechanical properties via siloxane equilibration” in J. Mater. Chem. A, 2018, 6, 10184-10188, DOI: 10.1039/C8TA02102C), which deals with easy synthetic access to rigid epoxy vitrimers which have outstanding mechanical properties and are obtained via siloxane equilibration. Here, X. Wu et al. cause a di(potassium) oligoaminopropylmethylsiloxanediolate to act as a dynamic hardener on the diglycidyl ether of ethoxylated bisphenol A and they obtain a so-called vitrimer.

In the context of their investigation, however, X. Wu et al. understand by the term “recycling” not the chemical degradation of the epoxy-siloxane copolymer structure, but rather the thermally induced equilibrium adjustment of the siloxane fraction in the copolymer in the sense of a dynamic siloxane equilibration catalysed by the potassium siloxanolate bound to the siloxane molecule. The process described there by X. Wu et al. is capable of healing microcracks in the epoxy-siloxane copolymer structure.

In contrast to a controlled chemical degradation of the epoxy-siloxane copolymer structure, in which the number of SiO bonds increases significantly during the reaction as a result of the added reactants and the average molar mass of the polymer body decreases accordingly, with the catalysed dynamic siloxane equilibration described by X. Wu et al. it is the case that the number of SiO bonds and in association therewith the average molar mass of the epoxy-siloxane copolymer remain constant, as can be deduced from the diagram 1 shown in ibid. at the bottom of page 10185. In this respect, X. Wu et al. provide no indication of a controlled chemical degradation of the epoxy-siloxane copolymer structure in the sense of actual recycling of material.

Wenyiu Wu Klingler, Valentin Rougier, Zhenyu Huang, Damdarudhar Parida, Sandro Lehner, Andri Casutt, Daniel Rentsch, Karin Brändli Hedlund, Gion Andrea Barandun. Veronique Michaud and Sabyasachi Gaan have recently reported an epoxy resin (W. W. Klingler et al. “Recyclable flame retardant phosphonated epoxy based thermosets enabled via reactive approach” in Chemical Engineering Journal 466 (2023), 143051, DOI:10.1016/j.cej.2023.143051) which is actually a thermoset but which in contrast to other thermosets can be melted like a thermoplastic and is obtained by the incorporation of a spirocyclically structured bis-phosphonic ester into the epoxy resin matrix and thus represents a so-called vitrimer. A reversible, thermally induced transesterification reaction causes the opening or ring closure of the spirocyclic phosphonate incorporated into the polymer chains of the epoxy resin. In the event of such opening, the polymer chains become less closely crosslinked, allowing the resin to be melted and deformed. Convinced of the flame-retardant effect of the phosphonic ester on the epoxy resin, W. W. Klingler et al. hope to be able to extend the principle in such a way that they can also offer a solution for the recycling of fibre-reinforced epoxy resins. However, it remains to be seen whether a resin that remains intact in its essential polymer structure can be realized by a fibre web at all.

Focusing on silicon-containing compositions that after curing can be converted into their thermoplastic counterpart (i.e. non-crosslinked plastic) by treatment with an acidic solution, US 2022/0356145 A1 deals specifically with the incorporation of silicon-derived, amino-functional hardeners or curing agents into epoxy resin networks and in the recycling step makes use of the acidic-hydrolytic instability of the ≡SiOC bonds contained therein. The US 2022/0356145 A1 hardeners or curing agents are always compounds that derive from a single silicon atom. In addition to difunctional R₂SiO_{2/2} structures (=D units) and trifunctional RSiO_{3/2} structures (=T units), tetrafunctional SiO_{4/2} structures (=Q units), in which each individual silicon atom is surrounded by 4 oxygen atoms, are used specifically in US 2022/0356145 A1.

The M, D, T, Q nomenclature for the description of the structural units of organopolysiloxanes is known from the literature; see e.g. Walter Noll, Chemie und Technologie der Silicone, Verlag Chemie GmbH, Weinheim, pages 1 to 13 (1960).

In addition to the isolation of carbon fibres or glass fibres from the thermoset composite material, US 2022/0356145 A1 describes how the initial thermoset silicone-containing compositions can be recovered as a thermoplastic product and how this degradation product could be employed in plastics applications that use extrusion processes, for example.

WO 2021/140434 A1 teaches the use of slow-reacting, recyclable epoxy resin systems for structural composite materials, wherein the hardener component has at least one cleavable bond, which is derived from either of the acetal grouping, the ketal grouping, the formal grouping, the orthoester grouping, the orthocarbonate grouping or, in particular, the siloxy bond (≡SiOC bond). In one example of WO 2021/140434 A1, it is stated that the epoxy resin glass fibre composite material produced using tris(2-aminobutoxy)methylsilane as hardener can be dissolved at 80° C. in acetic acid in 3 hours such that in addition to the recyclable glass fibre web and other supporting components, a thermoplastic polymer is isolated after neutralization and coagulation of the resin body solution separated off.

However, the difficult-to-predict tendency towards cleavage of the hydrolytically extremely unstable ≡SiOC bonds makes these molecular predetermined breaking points a risk in terms of durability and lifetime of the composite material, so that when using these technologies, the coating material has a special safety function. In particular, the rotor blades of large wind turbines, under high mechanical load, are exposed for years and decades to abrasion and weather influences such as severe temperature changes and to UV radiation in conjunction with changes in air humidity. These damaging influences are significantly increased once again in the case of the offshore installation of wind turbines.

The recycling concept, on the other hand, appears to be motivated by the desire to perform delamination, debonding or structural dissolution of the resin-impregnated composite material preferably really only when the technical service life of the article manufactured from it has been reached. Preferably, the fibre composite material should not be damaged or disintegrated, with loss of mechanical strength, before the planned use has expired. The recycling of the fibre composite material initiated by the dissolution process should therefore preferably be switchable arbitrarily (on demand). The concepts of delamination and debonding are known to the skilled person. Thus, delamination preferably comprises the removal of adhesion, e.g. the process of the detachment of layers in composite materials, more preferably in fibre composite materials. Debonding preferably means loss of adhesion between fibres or fibre fabrics and a composite matrix, such as an epoxy resin.

EP4349884 A1 describes a process for the production of one or more alkoxysiloxanes by thermal reaction of a waste silicone with an alkali metal alkoxide and an alcohol. EP4349884 A1 performs a first step of reacting the waste silicone by mixing with an alcohol and an alkali metal alkoxide with introduction of heat, without the removal of any water from the reaction mixture, in particular without the use of solvents forming azeotropes with water and/or without the use of further water-removing agents. The reaction mixture resulting from this reaction is neutralized in a second step according to EP4349884 A1 with the help of at least one Brönsted acid, optionally with addition of a solvent, and the solid components are separated off, in particular filtered off, then the one or more alkoxysiloxanes are isolated by thermal separation of volatile compounds.

EP4349882 A1 is concerned with a process for the production of one or more alkoxysiloxanes by thermal reaction of siloxane substrates with an alkali metal alkoxide and an alcohol, wherein, in a first step, the siloxane substrate is reacted by mixing with an alcohol and an alkali metal alkoxide with introduction of heat, without the removal of any water from the reaction mixture, in particular without the use of solvents forming azeotropes with water and/or without the use of further water-removing agents, and the reaction mixture resulting from the first step is neutralized in a second step by adding a Brönsted acid and optionally by adding a solvent, preferably solid constituents are filtered off and then the one or more alkoxysiloxanes are isolated by thermal separation of volatile compounds, the siloxane substrate being selected from the group consisting of hexamethylcyclotrisiloxane (D₃), octamethylcyclotetrasiloxane (D₄), decamethylcyclopentasiloxane (D₅), dodecamethylcyclohexasiloxane (D₆), mixtures of cyclic-branched siloxanes of D/T type, silicone oils, polydimethylsiloxanediols and α,ω-divinylsiloxanes.

Epoxy hybrid resins modified with low molecular weight siloxanes were described by Henryk Galina, Hieronim Maciejewski and Piotr Murias in “Epoxy resins modified with reactive low molecular weight siloxanes” back in European Polymer Journal 48 (2012), 769-773, DOI:10.1016/j.eurpolymj.2012.01.009), where, as an organic epoxy resin system, commercial epoxy resin Epidian® 6 is combined with triethylenetetramine as hardener with fractions of respectively 3, 5, 10 or 15 percent by weight of siloxane modifiers, where 1,3-bis(glycidyloxypropyl)-1,1,3,3-tetramethyldisiloxane and 1,3-bis(aminopropyl)-1,1,3,3-tetramethyldisiloxane are used respectively as siloxane modifiers, each replacing fractions of the organic epoxy resin or the amine hardener component in accordance with their amount, and the resulting siloxane-modified epoxy resin formulations are homogenized and treated both for 24 hours at room temperature and for post-curing at 100° C. for 5 hours and then subjected to extensive mechanical tests. The authors Henryk Galina, Hieronim Maciejewski and Piotr Murias show that both the diepoxy and diaminodisiloxane modifications made, depending on the amount of siloxane added in each case, reduce the glass transition temperature of the polymer obtained, reduce the flexural strength and the dynamic shear modulus, but increase the impact strength of the epoxy-siloxane hybrid resin obtained.

Against this background, for example, a general challenge can be seen in dealing with the degradation of epoxy hybrid resin, preferably, for example, with a view to the possible recycling of epoxy hybrid resin-based composite materials, more preferably, for example, with a view to the possible recycling of wind turbine rotor blades containing epoxy-hybrid resin-based composite materials.

### SUMMARY OF THE INVENTION

The specific object of the present invention was to contribute to the degradation of epoxy hybrid resin, preferably to provide a method for the degradation of epoxy hybrid resin which is able to facilitate the degradation of epoxy hybrid resin that contains at least one siloxane chemically incorporated via at least two SiC bonds into the epoxy hybrid resin and a defined silicon fraction, and/or which preferably is also able to facilitate the degradation of composite materials which contain such epoxy hybrid resin and, for example, fibres, such as glass fibres. The epoxy hybrid resin to be degraded according to the invention is a cured epoxy hybrid resin.

### DETAILED DESCRIPTION OF THE INVENTION

The subject of the invention is a method for the degradation of epoxy hybrid resin which contains at least one chemically incorporated siloxane,
wherein the at least one siloxane chemically incorporated in the epoxy hybrid resin is chemically incorporated into the epoxy hybrid resin via at least two SiC bonds, and wherein the silicon fraction, expressed in percent by mass of silicon, based on the total epoxy hybrid resin is
1.5 percent by mass≤silicon fraction≤10 percent by mass,
wherein the epoxy hybrid resin is contacted with a mixture of at least one alkali metal alkoxide and at least one alcohol.

Surprisingly, the inventors found that such epoxy hybrid resins not only can be ideal candidates for the production of fibre composite materials, preferably glass fibre composite materials, but also can address in particular the aspect of their reusability, in the sense that the degradation of epoxy hybrid resin in the manner of the invention can enable, for example, the recovery of glass fibres from corresponding glass fibre composite materials which contain such epoxy hybrid resin.

The degradation of epoxy hybrid resin according to the invention is made possible by the invention's induced cleavage of SiOSi bonds in the epoxy hybrid resin, which preferably causes decomposition of the epoxy hybrid resin. This can then also enable the degradation of aforesaid composite materials, with the invention's induced cleavage of SiOSi bonds in the epoxy hybrid resin leading to delamination and debonding in the composite material.

The term “epoxy hybrid resin” is understood for the purposes of this invention to mean a cured epoxy hybrid resin which has at least one siloxane chemically incorporated into the epoxy hybrid resin via at least two SiC bonds. The known reaction between epoxides and amines can be utilized in this regard, for example. The linear reactive siloxanes which can be preferably used for this purpose in accordance with the invention preferably have epoxy- and/or primary amino group-carrying radicals in their end groups, said radicals being linked by a divalent hydrocarbon coupler which may be aliphatic, aliphatic-cycloaliphatic or aromatic and is bonded to the organopolysiloxanyl radical via an SiC bond, and which may also contain heteroatoms, such as preferably oxygen and/or nitrogen.

For the purposes of this invention, siloxane is understood preferably to be an organopolysiloxane, i.e. a compound which has at least one SiOSi grouping, wherein the oxygen contained in the SiOSi grouping preferably links structural elements of the type (—R₂Si—) with each other, where R independently of each other is selected from the group consisting of aliphatic and aromatic radicals; preferably. R independently of each other is selected from the group consisting of methyl, ethyl and phenyl. For the purposes of this invention, organopolysiloxanyl radical is understood accordingly to be a divalent radical derived from organopolysiloxane, which preferably has the following structure:

—R₂Si—(OR₂Si)x-OSiR₂—
wherein R independently of each other is selected from the group consisting of aliphatic and aromatic radicals: preferably, R independently of each other is selected from the group consisting of methyl, ethyl and phenyl,
and wherein for x: 0≤x≤8, preferably 0≤x≤5, more preferably x=0.

Reactive siloxane is preferably understood for the purposes of this invention to be a linear organopolysiloxane, which preferably has epoxy- and/or primary amino group-carrying radicals in its end groups, said radicals being linked by a divalent hydrocarbon coupler which may be aliphatic, aliphatic-cycloaliphatic or aromatic and is bonded to the organopolysiloxanyl radical via an SiC bond, and which may also contain heteroatoms, such as preferably oxygen and/or nitrogen.

For the purposes of this invention, hydrocarbon coupler is understood preferably to be the divalent coupler which may be aliphatic, aliphatic-cycloaliphatic or aromatic and is bonded to the organopolysiloxanyl radical via an SiC bond, and which may also contain heteroatoms, such as preferably oxygen and/or nitrogen, and which preferably carries epoxy and/or primary amino group radicals. This coupler thus bridges the organopolysiloxanyl residue with the respective reactive end group, preferably the epoxy- and/or primary amino group-bearing end group.

In order to obtain the “epoxy hybrid resin” according to the invention, for example, the at least one reactive siloxane can be chemically incorporated into the resulting epoxy hybrid resin via at least two SiC bonds by reaction with an organic epoxy component and/or an organic amine component. The resulting epoxy hybrid resin in which at least one siloxane is then chemically incorporated can thereafter be cured so that a cured epoxy hybrid resin is then present. The “epoxy hybrid resin” according to the invention is a cured epoxy hybrid resin.

For the purposes of this invention, the term “hybrid resin” means that the epoxy hybrid resin is chemically linked to at least one siloxane at the molecular level, with the at least one siloxane being chemically incorporated into the epoxy hybrid resin via at least two SiC bonds.

The provision of cured epoxy resins is well known to the skilled person and does not require any further explanation. For example, it can be carried out in a well-known manner by reaction of so-called epoxy components with at least one hardener, preferably at least one organic amine component, and subsequent curing. The curing process then preferably results in a so-called moulding material, since the curing process is preferably accompanied by shaping, so that a cured epoxy resin can preferably also be referred to as an epoxy resin moulding material.

Accordingly, the “epoxy hybrid resin” according to the invention can preferably also be referred to as an epoxy hybrid resin moulding material, in which at least one siloxane is chemically incorporated according to the invention.

The epoxy hybrid resin to be degraded according to the invention is a cured epoxy hybrid resin and is notable in that it has at least one siloxane chemically incorporated in the epoxy hybrid resin, wherein the at least one siloxane is chemically incorporated into the epoxy hybrid resin via at least two SiC bonds.

Siloxanes preferred according to the invention and suitable for chemical incorporation into the epoxy hybrid resin are reactive siloxanes. Reactive siloxanes preferred according to the invention are, for example, organopolysiloxanes of the kind described in more detail below.

One method preferred according to the invention is notable in that the epoxy hybrid resin is the reaction product of at least one epoxy resin compound and at least one organopolysiloxane selected from the group consisting of compounds of the formulae (I) and (II)

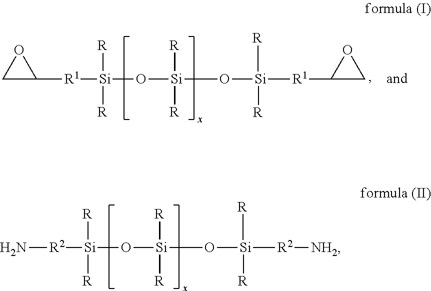

where
R, independently of each other is selected from the group consisting of aliphatic and aromatic radicals; preferably, R independently of each other is selected from the group consisting of methyl, ethyl and phenyl,
R¹, independently of each other is a divalent hydrocarbon coupler which may be aliphatic, aliphatic-cycloaliphatic or aromatic and is bonded to the organopolysiloxanyl radical via an SiC bond, and which may also contain heteroatoms, such as preferably oxygen and/or nitrogen,
R², independently of each other is a divalent hydrocarbon coupler which may be aliphatic, aliphatic-cycloaliphatic or aromatic and is bonded to the organopolysiloxanyl radical via an SiC bond, and which may also contain heteroatoms, such as preferably oxygen and/or nitrogen,
and wherein for x, independently of each other: 0≤x≤8, preferably 0≤x≤5, more preferably x=0.

With preference according to the invention, the epoxy hybrid resin to be degraded according to the invention can be obtained, for example, in that the at least one siloxane which is to be chemically incorporated into the epoxy hybrid resin is introduced into an epoxy resin compound consisting, for example, of organic epoxy component and organic amine component, and is mixed and through-cured with said compound. With preference according to the invention, for example, one or more than one additive customary for the production of epoxy resins, such as accelerators, antioxidants, heat stabilizers, light stabilizers or UV stabilizers, biocides, surfactants, solvents, dyes, fillers or mixtures thereof, can optionally also be used. The use of such additives is purely optional.

Organic epoxy components for the production of epoxy resins are well known to the skilled person from the prior art. Organic epoxy components preferred according to the invention may for example comprise and preferably be: the diglycidyl ethers of the known bisphenols, such as the diglycidyl ethers of bisphenol A, bisphenol AP, bisphenol AF, bisphenol B, bisphenol BP, bisphenol C, bisphenol E, bisphenol F, bisphenol G, bisphenol M, bisphenol S, bisphenol P, bisphenol PH, bisphenol TMC, bisphenol Z, the derivatives thereof, in each case alone or any mixtures thereof, and preferably, where appropriate additionally, the epoxy-functional compounds which can be used preferably as reactive diluents, such as 1,4-butanediol diglycidyl ether, neopentyl glycol diglycidyl ether, hexanediol diglycidyl ether, cyclohexanedimethanol diglycidyl ether, trimethylolpropane di or triglycidyl ether, phenyl glycidyl ether, cresyl glycidyl ether, guiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, glycidyl ethers of C8 to C10 alcohols, glycidyl ethers of C12 to C14 alcohols, glycidyl ethers of C13 to C15 alcohols, in each case alone or any mixtures thereof. In the case of the reactive diluents, C12-C14 alkyl glycidyl ethers and 1,4-butanediol diglycidyl ether and mixtures thereof are particularly preferred according to the invention.

Organic amine components for the production of epoxy resins are also well known to the skilled person from the prior art. Organic amine components preferred according to the invention may for example comprise, and preferably be:
(a) aliphatic, cycloaliphatic or arylaliphatic polyamines with a primary and at least one secondary amino group, in each case alone or mixtures thereof, preferably N-benzyl-1,2-ethanediamine, N-benzyl-1,2-propanediamine, N-benzyl-2-methyl-1,5-pentanediamine, N-benzyl-1,3-bis(aminomethyl)benzene, N-(2-ethylhexyl)-1,3-bis(aminomethyl)benzene, 2-aminoethylpiperazine, 3-dimethylaminopropylamine (DMAPA), 3-(3-(dimethylamino) propylamino) propylamine (DMAPAPA), N-benzyl diethylenetriamine, N-benzyltriethylenetramine, N″-benzyl-N,N′-bis(3-aminopropyl)ethylenediamine or addition products of these polyamines with monoepoxides or diepoxides, in each case alone or mixtures thereof;
(b) aliphatic, cycloaliphatic or arylaliphatic polyamines with at least two primary amino groups, in each case alone or mixtures thereof, preferably 2,2-dimethyl-1,3-propanediamine, 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2(4),4-trimethyl-1,6-hexanediamine (TMD), 1,7-heptanediamine, 1,8-octanediamines, 1,9-nonanediamine, 1,10-decanediamine, 1,11-undecanediamine, 1,12-dodecanediamine, 1,2-, 1,3- or 1,4-diaminocyclohexane, 1,3-bis(aminomethyl)cyclohexane, 1,4-bis(aminomethyl)cyclohexane, bis(4-aminocyclohexyl) methane, bis(4-amino-3-methylcyclohexyl) methane, bis(4-amino-3-ethylcyclohexyl) methane, bis(4-amino-3,5-dimethylcyclohexyl) methane, bis(4-amino-3-ethyl-5-methylcyclohexyl) methane, 1-amino-3-aminomethyl-3,5,5-trimethylcyclohexane (isophoronediamine or IPDA, such as e.g. VESTAMIN® IPD and VESTAMIN® IPD eCO from Evonik), 2(4)-methyl-1,3-diaminocyclohexane, 2,5(2,6)-bis(aminomethyl) bicyclo[2.2.1]heptane (NBDA), 3(4), 8(9)-bis(aminomethyl)tricyclo[5.2.1.02,6]decane, 1,4-diamino-2,2,6-trimethylcyclohexane (TMCDA), 1,8-menthanediamine, 3,9-bis(3-aminopropyl)-2,4,8,10-tetraoxaspiro[5.5]undecane, m-xylylenediamine (MXDA), p-xylylenediamine, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl) polytetrahydrofuran or other polytetrahydrofurandiamines, polyoxyalkylenedi- or -triamines, in particular Jeffamine® D-230, Jeffamine® D-400, Jeffamine® D-2000, Jeffamine® EDR-104, Jeffamine® EDR-148, Jeffamine® EDR-176, Jeffamine® T-403, Jeffamine® T-3000 or Jeffamine® T-5000 (all from Huntsman), bis(6-aminohexyl)amine (BHMT), diethylenetriamine (DETA), triethylenetetramine (TETA), tetraethylenepentamine (TEPA), pentaethylenhexamine (PEHA) or higher homologues derived therefrom, dipropylenetriamine (DPTA), N-(2-aminoethyl)-1,3-propanediamine (N3-amines), N,N′-bis(3-aminopropyl)ethylenediamine (N4-amines), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine, N,N′-bis(3-amino-1-ethylpropyl)-2-methyl-1,5-pentanediamine or addition products of these polyamines with monoepoxides or diepoxides, in each case alone or mixtures of the aforesaid;
(c) N-benzyl-1,2-ethanediamine, N-benzyl-1,2-propanediamine, TMD, 1,2-, 1,3- or 1,4-diaminocyclohexane, 1,3-bis(aminomethyl)cyclohexane, 1,4-bis(aminomethyl)cyclohexane, bis(4-aminocyclohexyl) methane, IPDA, 2(4)-methyl-1,3-diaminocyclohexane, polyoxypropylenediamine with an average molecular weight Mn in the range from 170 to 500 g/mol, polyoxypropylenediamine with an average molecular weight Mn in the range from 300 to 500 g/mol, TETA, TEPA, PEHA, N4-amines, in each case alone or mixtures of the aforesaid;
or
(d) any mixtures of the aforesaid groups (a) to (c).

For the purposes of this invention, epoxy resin compound is preferably a mixture comprising, preferably consisting of, at least one organic epoxy component and at least one organic amine component. With preference according to the invention, the epoxy resin compound may optionally, for example, be further admixed with one or more than one additive customary for the production of epoxy resins, such as accelerators, antioxidants, heat stabilizers, light stabilizers or UV stabilizers, biocides, surfactants, solvents, dyes, fillers or mixtures thereof, or these may optionally be contained in the epoxy resin compound. The use of such additives is purely optional.

In order to obtain epoxy hybrid resins preferred according to the invention, for example, reactive siloxane provided with epoxy and/or amine end groups can be added to the epoxy resin compound in question before complete curing, so that the epoxy hybrid resin according to the invention can be produced in this way and after curing.

With preference according to the invention, the epoxy hybrid resin to be degraded according to the invention can also be obtained, for example, by allowing an organic epoxy component to react exclusively with an amino group-containing organosiloxane, so that the epoxy hybrid resin according to the invention can be produced in this way and after curing.

With preference according to the invention, the epoxy hybrid resin to be degraded according to the invention can also be obtained, for example, by allowing an organic epoxy component to first pre-react with an amino group-containing organopolysiloxane, before the prepolymer formed in this way is then mixed with an organic amine component, so that the epoxy hybrid resin according to the invention can be produced in this way and after curing.

With preference according to the invention, the epoxy hybrid resin to be degraded according to the invention can also be obtained, for example, by allowing an organic amine component to first pre-react with an epoxy group-containing organopolysiloxane, before the prepolymer formed in this way is then mixed with the organic epoxy component, so that the epoxy hybrid resin according to the invention can be produced in this way and after curing.

According to the invention, it is preferred if, for example, in addition to the use of the preferably usable diglycidyl ethers of the known bisphenols as epoxy components, additionally further epoxy-functional compounds are used as reactive diluents, in particular for adjusting the rheology of the epoxy hybrid resin.

Employable preferably for the production of the epoxy hybrid resin to be degraded according to the invention are
(a) at least one organopolysiloxane containing epoxy groups, according to the following formula,

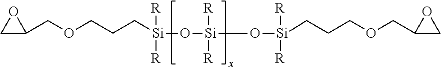

wherein the radicals R are selected independently of each other from the group consisting of methyl, ethyl and phenyl, and where for x: 0≤x≤8, preferably 0≤x≤5, more preferably x=0 and/or
(b) at least one organopolysiloxane containing amino groups according to the following formula

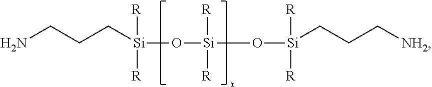

wherein the radicals R are selected independently of each other from the group consisting of methyl, ethyl and phenyl, and where for x: 0≤x≤8, preferably 0≤x≤5, more preferably x=0.

Likewise employable preferably for the production of the epoxy hybrid resin to be degraded according to the invention is at least one epoxy group-containing organopolysiloxane of the general formula:

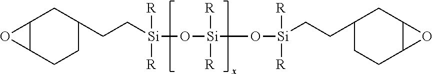

where R independently of each other is selected from the group consisting of aliphatic and aromatic radicals; preferably. R independently of each other is selected from the group consisting of methyl, ethyl and phenyl, and where for x: 0≤x≤8, preferably 0≤x≤5, more preferably x=0.

Likewise employable preferably for the production of the epoxy hybrid resin to be degraded according to the invention is at least one amino group-containing organopolysiloxane of the general formula

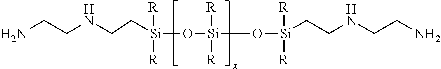

where R independently of each other is selected from the group consisting of aliphatic and aromatic radicals; preferably, R independently of each other is selected from the group consisting of methyl, ethyl and phenyl, and where for x: 0≤x≤8, preferably 0≤x≤5, more preferably x=0.

One method preferred according to the invention is notable in that the epoxy hybrid resin to be degraded according to the invention comprises the reaction product of at least one epoxy resin compound and at least one organopolysiloxane selected from the group consisting of compounds of the formulae (III), (IV), (V) and (VI)

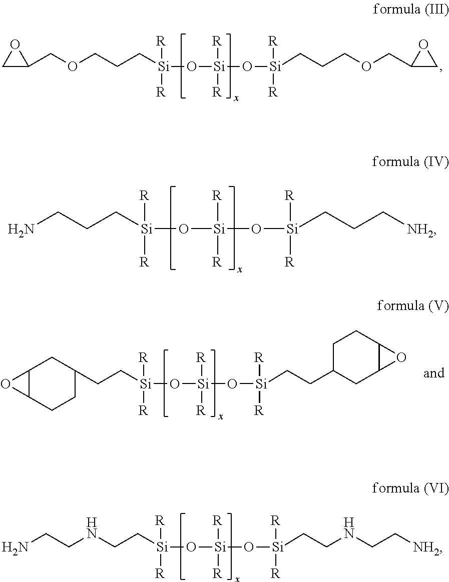

wherein
R, independently of each other, is selected from the group consisting of aliphatic and aromatic radicals; preferably, R independently of each other is selected from the group consisting of methyl, ethyl and phenyl,
and wherein for x, independently of each other: 0≤x≤8, preferably 0≤x≤5, more preferably x=0.

The epoxy hybrid resin to be degraded according to the invention is preferably suitable as a matrix material for glass fibre composite materials. It is preferably suitable for treating, preferably impregnating and/or moulding, of fibres, preferably of fibre webs and/or fibre mats, such as nonwoven glass fibre and/or carbon webs, for example, and thus for the construction of composite materials, which can preferably be used in demanding technical applications, such as the construction of rotor blades for wind turbines, for example.

Preferably after or with the expiration of the technical life of the epoxy hybrid resin to be degraded according to the invention, the present invention can not only allow the epoxy hybrid resin in question to be degraded, but can also allow optionally contained fibre material to be easily freed from the epoxy hybrid resin that intersperses or envelops it. The consequent possibility of recovering optionally contained fibre material is a major advantage of the present invention. The method according to the invention is gentle on materials, so that it is possible, for example, to recover large sheets of any employed glass fibre webs undamaged, so that they can be used for other, demanding purposes. This distinguishes the method according to the invention fundamentally, for example, from the known pyrolysis methods, from which any employed glass fibre webs emerge only with heavy soiling or damage.

According to the invention, the epoxy hybrid resin to be degraded is contacted with a mixture of at least one alkali metal alkoxide and at least one alcohol. With preference according to the invention, a solution of at least one alkali metal alkoxide in at least one alcohol can be used. With preference according to the invention, the epoxy hybrid resin to be degraded may also be, for example, a constituent of a glass fibre composite material or constituent of an object containing the composite material and/or the epoxy hybrid resin to be degraded, such as preferably a constituent of a rotor blade of a wind turbine.

One method preferred according to the invention is characterized in that the epoxy hybrid resin and/or an object containing the epoxy hybrid resin, such as a glass fibre composite material or a corresponding rotor blade of a wind turbine, for example, is moved in the mixture of at least one alkali metal alkoxide and at least one alcohol and/or is washed by the mixture of at least one alkali metal alkoxide and at least one alcohol.

For example, in the case of objects containing epoxy hybrid resin that require a lot of space owing to their dimensions and/or shape, like preferably corresponding rotor blades of wind turbines, it may be particularly preferable according to the invention to wash the objects in question in a suitable container at rest with the mixture of at least one alkali metal alkoxide and at least one alcohol, preferably using pumps and/or washing nozzles, which can for example be of static, that is, stationary or, for example, movable configuration.

A suitable container could be, for example, a tub-shaped container which can accommodate the object in such a way that it is possible to contact the mixture of at least one alkali metal alkoxide and at least one alcohol with the object.

With preference according to the invention, the epoxy hybrid resin or an object containing the epoxy hybrid resin is contacted, preferably with effective mixing, with a mixture of at least one alkali metal alkoxide and at least one alcohol, preferably with introduction of heat.

It is further preferred according to the invention that this “contacting” is carried out at a pressure in the range from 0.5 bar to 5 bar, more preferably 0.8 to 2 bar, still more preferably 0.9 to 1.2 bar, preferably e.g. at atmospheric pressure.

With particular preference according to the invention, the “contacting” can be carried out without additional pressure application, in particular carried out preferably under normal pressure, that is, at an air pressure of preferably 1013.25 hPa.

According to an alternative preferred embodiment, however, it may also be particularly preferred according to the invention if this “contacting” is carried out under overpressure conditions in a pressure-resistant reactor, preferably when using those alcohols which have boiling points below 100° C. at normal pressure (1013.25 hPa). Any pressure build-up that may be recorded when using those alcohols which have boiling points below 100° C. at normal pressure (1013.25 hPa) may be autogenous in nature, for example, and may be for example due to the vapour pressure of the system components involved therein. Preferably, the reactor can also be supplied with an optional inert gas cushion, if desired.

At least one alcohol is used in the method according to the invention.

With preference according to the invention, the at least one alcohol is selected from the group consisting of linear alkanols, branched alkanols and cyclic alkanols, preferably independently of each other having 1 to 18 carbon atoms, further preferably independently of each other having 1 to 10 carbon atoms, very preferably independently of each other having 1 to 2 carbon atoms; with particular preference, methanol and/or ethanol are used.

With preference according to the invention, the at least one alcohol is used in a total amount of 100 to 2000% by mass, preferably from 100 to 1800% by mass, more preferably from 110 to 1700% by mass, % by mass respectively based on the total amount of the at least one epoxy hybrid resin.

At least one alkali metal alkoxide is used in the method according to the invention. Alkali metal alkoxides are well known to those skilled in the art. Alkali metal alkoxides are commercially available both as solids and in the form of their alcoholic solutions. The skilled person is also familiar with processes for the production of alkali metal alkoxides; for example, a number of suitable processes for the production of alkali metal alkoxides are identified in paragraphs to of European patent application EP 4 349 884 A1.

With preference according to the invention, alkali metal alkoxides are preferably understood in the context of this invention to mean compounds of the general formula:

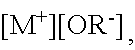

wherein
M is an alkali metal, selected from the group consisting of Li, Na and K; preferably, M is Na or K, and wherein
R represents a linear, branched or cyclic alkyl radical, preferably having 1 to 10 carbon atoms, particularly preferably having 1 to 6 carbon atoms, very particularly preferably having 1 or 2 carbon atoms.

With preference according to the invention, at least one alkali metal alkoxide is selected from the above-mentioned compounds of the general formula [M⁺][OR⁻].

Most preferred according to the invention is the use of at least one alkali metal alkoxide selected from the group consisting of potassium ethoxide, sodium ethoxide, potassium methoxide and sodium methoxide. It is possible to employ one or more alkali metal alkoxides.

With preference according to the invention, the at least one alkali metal alkoxide is used in a total amount of 1 to 10 percent by weight, preferably from 2 to 7 percent by weight, more preferably from 3 to 6 percent by weight, percent by weight respectively based on the total amount of the at least one alcohol.

One method preferred according to the invention is characterized in that the contacting of the epoxy hybrid resin with the mixture of at least one alkali metal alkoxide and at least one alcohol takes place with supply of heat energy (also called “thermal energy” or simply “heat”).

With preference according to the invention, the contacting of the epoxy hybrid resin with the mixture of at least one alkali metal alkoxide and at least one alcohol takes place in a period of 1 to 10 hours, more preferably in a period of 2 to 4 hours.

With preference according to the invention, the contacting of the epoxy hybrid resin with the mixture of at least one alkali metal alkoxide and at least one alcohol takes place in a temperature range from 20° C. to 100° C., more preferably from 40 to 85° C.

In carrying out the method according to the invention for the degradation of epoxy hybrid resin, preferably an alkaline, alcoholic solution may be obtained, which can be easily separated from any solid bodies present, such as in particular from glass fibre and/or carbon fibre fabrics, for example by decanting.

It is preferred according to the invention to separate off this alkaline-alcoholic solution and preferably to subject it to neutralization by means of a Brönsted acid, particularly preferably with acetic acid, and further it is preferred according to the invention to separate off the precipitated salt afterwards, preferably by decanting and/or filtration.

It is preferred according to the invention to then subject the salt-freed, alcoholic solution to thermal separation and to separate off the alcoholic component, preferably by distillation. With preference according to the invention, it is possible here to obtain a residue which is flowable but viscous at T=25° C. On a purely optional basis, said residue can optionally be crosslinked under the influence of moisture to form a polymeric solid, which is no longer soluble in alcohols.

Without being tied to a particular theory, the inventors assume that the siloxane chemically incorporated into the epoxy hybrid resin before is cleaved at the SiOSi bonds in the course of the process according to the invention, forming SiOC bonds (Si-alkoxy).

The inventors, again without being tied to a particular theory, also assume that in this way, an epoxy resin is formed which is linked, via an SiC bond and a carbon bridge which optionally also has heteroatoms such as oxygen, to an alkoxy-Si grouping, which can, for example, if desired, be condensed with crosslinking under the effect of moisture, possibly even by exposure to air humidity.

Surprisingly, it was found in the context of the present invention that for the degradation according to the invention, preferably for detachment and/or dissolution, of the epoxy hybrid resin, in particular from an object containing the epoxy hybrid resin, no quantitative reaction is required in order to achieve, for example, complete detachment of the resin from a glass fibre web. For example, partial degradation according to the invention, preferably in the range from about 50 to 70 percent and considered as cleavage of the siloxanyl bonds (SiOSi bonds) contained in the epoxy hybrid resin, is already completely sufficient to achieve, for example, the complete detachment of the resin from the carrier material.

One method preferred according to the invention is characterized in that the epoxy hybrid resin to be degraded according to the invention is a casting resin, a coating compound, an adhesive or a composite component or a constituent of one of the aforesaid.

One method preferred according to the invention is notable in that the epoxy hybrid resin to be degraded according to the invention is a constituent of a composite material which, in addition to the epoxy hybrid resin, comprises at least one further material, preferably selected from the group consisting of glass fibres, carbon fibres, polymer fibres and metal fibres. It is preferred according to the invention that during or after the degradation of the epoxy hybrid resin, the at least one further material, preferably glass fibres, is separated off and recovered.

One method preferred according to the invention is characterized in that the epoxy hybrid resin to be degraded according to the invention is a rotor blade or constituent of a rotor blade.

The examples which follow serve merely to further elucidate the present invention and do not constitute any restriction of the present invention at all.

### EXAMPLES

²⁹Si-NMR spectroscopy was used for reaction monitoring in all examples.

In the context of this invention, the ²⁹Si NMR samples were analysed at a measurement frequency of 79.49 MHz in a Bruker Avance III spectrometer equipped with a 287430 sample head with gap width 10 mm, dissolved at 22° C. in CDCl₃ and against a tetramethylsilane (TMS) external standard [δ(²⁹Si)=0.0 ppm].

### Example 1 (According to the Invention)

### Production of an Epoxy Hybrid Resin

4.0 g of the commercially available epoxy component DIPOXY®-2K-700 component A (DIPOXY® GERMANY) were intensively mixed with 2.4 g of 1,3-bis(3-aminopropyl)tetramethyldisiloxane. A portion of this freshly prepared epoxy hybrid resin compound was then applied to two rectangular glass fibre webs lying edge-flush one above the other, with dimensions of 4 cm×5 cm, so that interspersion of the glass fibre support fabric was as complete and homogeneous as possible. With the help of two transparent polyethylene films applied to the top and bottom of the resin-impregnated glass fibre support fabric, excess resin was then pressed out by hand, under the simple pressure of the fingers, paying particular attention to the pressing-out of any trapped air bubbles.

The epoxy hybrid resin-glass fibre composite material pre-assembled accordingly was allowed to through-cure for 24 hours at 22° C.

### a) Dissolution of the Epoxy Hybrid Resin-Glass Fibre Composite Material for Recovering the Glass Fibre Web Contained Therein

The epoxy hybrid resin-glass fibre composite material, freed of the polyethylene films, was admixed with 100 g of ethanol and 5.0 g of potassium methoxide (KOCH₃) in a 250 ml single-neck round-bottom flask. The single-neck round-bottom flask was mounted onto the hollow shaft of a rotary evaporator and then lowered into an oil bath of 80° C. for 6 hours with rotation. After just 2 hours of treatment, the dissolution of the epoxy hybrid resin from the glass fibre web with delamination (separation of the glass fibre web layers) was observed. After the end of 6 hours, the separated glass fibre webs were removed from the solution and washed with a small amount of ethanol and thereafter dried in the air.

### Example 2 (According to the Invention)

### Production of an Epoxy Hybrid Resin

In analogy to the procedure described in Example 1, a larger amount of the epoxy hybrid resin was first produced by intensively mixing 8.0 g of the commercially available epoxy component DIPOXY®-2K-700 component-A (DIPOXY® GERMANY) with 4.8 g of 1,3-bis(3-aminopropyl)tetramethyldisiloxane.

Contrasting with Example 1, the epoxy hybrid resin compound was not applied to glass fibre webs, but instead was allowed to through-cure in the air with a layer height of around 2 mm in substance for 24 hours at 22° C.

### a) Dissolution of the Epoxy Hybrid Resin

The epoxy hybrid resin compound was crushed into 5×5 mm platelets and these are admixed with 100 g of ethanol and 5.0 g of potassium methoxide (KOCH₃) in a 250 ml single-neck round-bottom flask. The single-neck round-bottom flask was mounted onto the hollow shaft of a rotary evaporator and then lowered into an oil bath of 80° C. for 6 hours with rotation. After just 2 hours of treatment, the complete dissolution of the epoxy-siloxane hybrid resin was observed. After the end of 6 hours, the slightly yellowish, alcoholic-alkaline solution was neutralized by adding 5.0 g of acetic acid. The precipitated salt was then separated from the neutralized solution by filtration via a pleated filter (MN 615 ¼).

Applying an auxiliary vacuum (oil pump), ethanol was stripped off at 22° C., with further salt precipitating. Re-filtration via a pleated filter (MN 615 ¼) yielded a clear solution from which ethanol was extracted in turn by applying an auxiliary vacuum at 22° C. The resulting viscous residue was dissolved in 10 ml of toluene and filtered again. The toluenic solution was further concentrated with the aid of an applied auxiliary vacuum until a highly viscous residue was isolated.

Accompanying ²⁹Si-NMR spectroscopy showed that around 70% of the original siloxane bonds were cleaved and that from them, ethoxydimethylsiloxy units bonded molecularly to the epoxy resin had arisen.

### Example 3 (According to the Invention)

### a) Preparation of an Amino-Functional Bisphenol A Derivative as an Epoxy Component

25 g of the commercially available epoxy component DIPOXY®-2K-700 Component-A (DIPOXY® GERMANY) were mixed intensively with 31.4 g of ethylenediamine (300% excess relative to the epoxy component) in 100 g of toluene, then stirred for 1 hour at 60° C. and then for another 2 hours at 80° C. At 70° C. and a pressure of 5 mbar, the volatiles were then distilled off over an hour on the rotary evaporator. The amino-functional bisphenol A derivative was isolated as a clear, viscous liquid.

### b) Production of an Epoxy Hybrid Resin

23.7 g of 1,3-bis(3-glycidyloxypropyl)tetramethyldisiloxane in solution in 100 ml of toluene were added to the aminic bisphenol A derivative still in the rotary evaporator's single-neck round-bottom flask. The colourless-clear reaction solution was conditioned at 70° C. for 3 hours on the rotary evaporator. After this period of time, an auxiliary vacuum was applied, with a final pressure of 5 mbar being established. After about 2 hours, a mechanically solid, through-cured epoxy hybrid resin layer remained on the inner flask wall.

### c) Dissolution of the Epoxy Hybrid Resin

The epoxy hybrid resin compound was admixed in the same flask with 100 g of ethanol and 5.0 g of potassium methoxide (KOCH₃). The single-neck round-bottom flask was mounted onto the hollow shaft of a rotary evaporator and then lowered into an oil bath of 80° C. for 6 hours with rotation. After just 4 hours of treatment, the complete dissolution of the epoxy hybrid resin was observed. After the end of 6 hours, the slightly yellowish, alcoholic-alkaline solution was neutralized by adding 5.0 g of acetic acid. The precipitated salt was then separated from the neutralized solution by filtration via a pleated filter (MN 615 ¼). Applying an auxiliary vacuum (oil pump), ethanol was stripped off at 22° C., with further salt precipitating. Re-filtration via a pleated filter (MN 615 ¼) yielded a clear solution from which ethanol was extracted in turn by applying an auxiliary vacuum at 22° C. The resulting viscous residue was dissolved in 10 ml of toluene and filtered again. The toluenic solution was further concentrated with the aid of an applied auxiliary vacuum until a highly viscous residue was isolated.

Accompanying ²⁹Si-NMR spectroscopy showed that around 70% of the original siloxane bonds had been cleaved and that from them, ethoxydimethylsiloxy units bonded molecularly to the epoxy resin had arisen.

Applying the thus-isolated residue to a watch glass and contacting it with air humidity resulted in a glassily transparent, through-cured polymer coating that could not be dissolved in ethanol.

### Example 4 (Comparative Example not According to the Invention)

Test for Dissolution of a Glass Fibre Composite Material Impregnated with a Commercial Epoxy Resin for Recovering the Glass Fibre Web Contained Therein

### a) Production of the Epoxy Resin-Impregnated Glass Fibre Composite Material

4.0 g of the commercially available epoxy component DIPOXY®-2K-700 component A (DIPOXY® GERMANY) were intensively mixed with 2.0 g of the amine component DIPOXY®-2K-700 component B. A portion of this freshly prepared epoxy resin compound was then applied to two rectangular glass fibre webs lying edge-flush one above the other, with dimensions of 4 cm×5 cm, so that interspersion of the glass fibre support fabric was as complete and homogeneous as possible. With the help of two transparent polyethylene films applied to the top and bottom of the resin-impregnated glass fibre support fabric, excess resin was then pressed out by hand, under the simple pressure of the fingers, paying particular attention to the pressing-out of any trapped air bubbles.

The epoxy resin-glass fibre composite material pre-assembled accordingly was allowed to through-cure for 24 hours at 22° C.

### b) Test for Dissolution of the Epoxy Resin-Impregnated Glass Fibre Composite Material

The epoxy resin-glass fibre composite material, freed of the polyethylene films, was admixed with 100 g of ethanol and 5.0 g of potassium methoxide (KOCH₃) in a 250 ml single-neck round-bottom flask. The single-neck round-bottom flask is mounted onto the hollow shaft of a rotary evaporator and then lowered into an oil bath of 80° C. for 6 hours with rotation. Neither dissolution nor detachment of the epoxy resin nor delamination phenomena (separation of the glass fibre web layers) could be observed on the glass fibre composite material.

1-13. (canceled)

14. A method for degrading an epoxy hybrid resin comprising at least one siloxane chemically incorporated into the resin via at least two Si—C bonds, wherein the silicon fraction, expressed as mass percent of silicon relative to the total resin, is equal to or greater than 1.5% and less than or equally to 10%, the method being characterized by contacting the epoxy hybrid resin with a mixture comprising at least one alkali metal alkoxide and at least one alcohol.

15. The method of claim 14, wherein the contacting of the epoxy hybrid resin with the mixture of at least one alkali metal alkoxide and at least one alcohol takes place while applying heat.

16. The method of claim 14, wherein the epoxy hybrid resin is moved in, or washed by the mixture of at least one alkali metal alkoxide and at least one alcohol.

17. The method of claim 14, wherein the contacting of the epoxy hybrid resin with the mixture of at least one alkali metal alkoxide and at least one alcohol takes place for a period of 1 to 10 hours.

18. The method of claim 17, wherein the contacting of the epoxy hybrid resin with the mixture of at least one alkali metal alkoxide and at least one alcohol takes place for a period of 2 to 4 hours.

19. The method of claim 18, wherein the contacting of the epoxy hybrid resin with the mixture of at least one alkali metal alkoxide and at least one alcohol takes place in a temperature range of from 20° C. to 100° C.

20. The method of claim 19, wherein the contacting of the epoxy hybrid resin with the mixture of at least one alkali metal alkoxide and at least one alcohol takes place in a temperature range of from 40° C. to 85° C.

21. The method of claim 14, wherein the at least one alcohol is selected from the group consisting of: linear alkanols, branched alkanols; cyclic alkanols and mixtures thereof.

22. The method of claim 21, wherein the at least one alcohol has 1 to 10 carbon atoms.

23. The method of claim 21, wherein the alcohol is methanol and/or ethanol.

24. The method of claim 14, wherein the alkali metal alkoxide has the formula [M⁺][OR⁻], wherein:
M is an alkali metal, selected from the group consisting of Li, Na and K; and
R is a linear, branched or cyclic alkyl radical.

25. The method of claim 14, wherein M is Na or K and R has 1 to 6 carbon atoms.

26. The method of claim 14, wherein the epoxy hybrid resin is the reaction product of:
(a) at least one epoxy resin compound, and
(b) at least one organopolysiloxane compound selected from formula I or formula II, 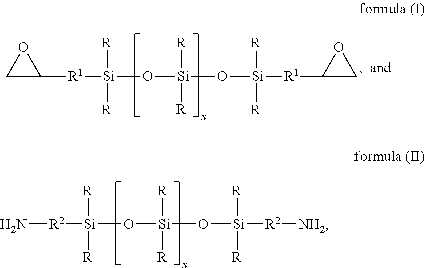
wherein:
R independently of each other is selected from the group consisting of aliphatic and aromatic radicals;
R¹ independently of each other is a divalent hydrocarbon coupler which may be aliphatic, aliphatic-cycloaliphatic or aromatic and is bonded to the organopolysiloxanyl radical via an SiC bond, and may also contain heteroatoms.
R² independently of each other is a divalent hydrocarbon coupler which may be aliphatic, aliphatic-cycloaliphatic or aromatic and is bonded to the organopolysiloxanyl radical via an SiC bond, and which may also contain heteroatoms,
and wherein, independently of each other, 0≤x≤8.

27. The method of claim 14, wherein the epoxy hybrid resin comprises the reaction product of at least one epoxy resin compound and at least one organopolysiloxane, said organopolysiloxane selected from the group consisting of compounds of the formulae (III), (IV), (V) and (VI): 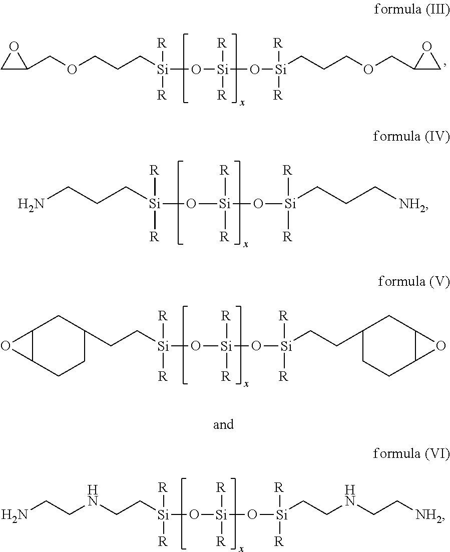
wherein
R independently of each other is selected from the group consisting of aliphatic and aromatic radicals:
and wherein for x, independently of each other: 0≤x≤8.

28. The method of claim 14, wherein R is independently methyl, ethyl or phenyl and x=0.

29. The method of claim 14, wherein the epoxy hybrid resin is a casting resin, a coating compound, an adhesive, a composite component or a constituent of one of the aforementioned.

30. The method of claim 14, wherein the epoxy hybrid resin is a constituent of a composite material which, in addition to the epoxy hybrid resin, comprises at least one further material.

31. The method of claim 30, wherein the epoxy hybrid further comprises a material selected from the group consisting of glass fibres, carbon fibres, polymer fibres and metal fibres.

32. The method of claim 30, wherein during or after the degradation of the epoxy hybrid resin, the at least one further material, is separated off and recovered.

33. The method of claim 32, wherein the epoxy hybrid resin is a rotor blade or a constituent of a rotor blade.
